(19) United States
(12) Patent Application Publication
(10) Pub. No.: US 2003/0150402 A1
(43) Pub. Date: Aug. 14, 2003

(54) Dog collar training aid

(76) Inventor: Pat Muller, South Beloit, IL (US)

Correspondence Address: KEITH FRANTZ, 401 WEST STATE STREET, SUITE 200, ROCKFORD, IL, 61101

(21) Appl. No.: 10/073,504

(22) Filed: Feb. 11, 2002

(51) Int. Cl. A01K 27/00

(52) U.S. Cl. 119/856

(57) ABSTRACT

A dog training aid for use with a collar and leash is adapted to assist in controlling and promoting desired behavior. The training aid includes a generally bone-shaped body provided with openings at each end for receiving the collar therethrough, and correction posts projecting rearwardly from the body for contacting the dog's neck and indicating a need for behavior correction when tension is applied with the leash.

### CROSS-REFERENCES TO RELATED APPLICATIONS

none.

### REFERENCE TO MICROFICHE APPENDIX

not applicable.

### STATEMENT REGARDING FEDERALLY SPONSORED RESEARCH OR DEVELOPMENT

not applicable.

### BACKGROUND OF THE INVENTION

1. Field of Invention

The present invention relates generally to apparatus to assist in handling, controlling, and training dogs.

More particularly, the invention relates to a dog training aid adapted to be attached to a collar and placed at a dog's neck to elicit desired behavior while training the dog.

2. Description of Prior Art

Since the domestication of the dog, various methods and training aids have been used to assist in correcting and refining the behavior of man's best friend. Prior training aids include several types of collars, and aids adapted for attaching to collars, that are intended to facilitate behavior modification in dogs. Some prior training collars carry electrical components that administer an electrical charge to a dog to indicate a need for behavior modification. Other prior methods of behavior modification include the use of non-electrical training collars with various prong arrangements.

Examples of electrical component collars are disclosed in Taylor U.S. Pat. No. 6,019,066 and Farkus et al. U.S. Pat. No. 5,911,199. Both of these devices control the behavior of a dog through electrical charges delivered to the dog's neck by prong shaped electrodes. While some trainers consider such electrical component collars to be effective, other trainers consider the use of electric shock to be too harsh for the more sensitive and gentler breeds of dogs, and in general, an inhumane method of training dogs.

Transue U.S. Pat. No. 1,603,222 discloses a non-electrical spring-like yoke that is placed around the neck of a dog and maintained in the open position by a trigger bar to which a rod and hook are attached. If the hook catches on a fence, bush, or some other object while the dog ranges a field or forest, the bar is dislodged, and the device suddenly and forcefully snaps shut, with inwardly projecting prongs banging against the dog's neck. Alternately, for example, the bar can be dislodged by an individual to indicate an undesirable behavior and elicit a desired behavior. However, not only is this device potentially dangerous to the dog if it is incorrectly sized, when the device suddenly and forcefully snaps shut, the dog can be badly startled, and the behavior that is desired to be corrected can become even worse.

Brose U.S. Pat. No. 2,394,144 discloses another non-electrical collar provided with sharp prongs that are spring biased toward and stationed at the exterior of the collar. Tension on a dog's leash advances the prongs inwardly through holes in the collar to contact the dog's flesh. As tension on the lead is reduced, the prongs retreat to the exterior position. However, such relatively sharp prongs can be potentially painful and cut into the flesh of the dog. In addition, such an arrangement is relatively complicated, requiring several moving parts, is therefore relatively expensive, and is subject to malfunction if one of the prongs becomes jammed in the collar.

Other non-electrical collars include conventional choke collars and chain pinch collars provided with prongs extending inwardly from the chain links. However, these collars are typically not favored for use as training aids because use of the choke collar can require severe tightening on the dog's neck before desired behavior correction is achieved, and the pinch collar is considered inhumane by may people.

In addition, none of the above-mentioned collars are suitable to be left on the dog after a walk or when training is finished because they present a danger of getting caught on objects as the dog roams freely in a house or outside.

A more recent non-electrical collar intended to be left on the dog is disclosed in Davies-Ross U.S. Pat. No. 6,101,980. In this instance, the collar is provided with prongs attached on the interior portion of the collar and embedded in a soft, resilient material. If tension is applied with the leash, the resilient material compresses and the prongs contact the dog's neck. As tension is reduced, the resilient material decompresses back to its original shape surrounding the prongs. However, to fabricate effectively, this collar is relatively expensive. The circular portion that surrounds the dog's neck must be made from a relatively flexible material, whereas the prongs must be relatively stiff to provide the desired correction. And the additional piece of resilient foam add additional expense to the collar.

Thus, it is apparent that there is a need for a non-electrical dog training aid that addresses the above-mentioned drawbacks and disadvantages of prior training aids, and in particular, that economically, effectively, and humanely permits correction of a dog's behavior without startling the animal, and without causing an undue amount of discomfort or pain.

### SUMMARY OF THE INVENTION

The general aim of the present invention is to provide a new and improved non-electrical dog training aid adapted to effectively and humanely permit control and correction of a dog's behavior.

A further aim of the invention is to provide a relatively inexpensive training aid that can be removably attached to a conventional buckle collar.

These and other objectives and advantages of the invention will become more apparent from the following detailed description when taken in conjunction with the accompanying drawings.

Briefly, a preferred embodiment of the invention includes a body with openings at each end for removably receiving a buckle collar therethrough, and posts projecting rearwardly from the center portion of the body and shaped with rounded ends for contacting a dog's neck with tension applied to a leash to notify the dog of misbehavior or that behavior correction is needed. In a preferred embodiment, two posts are positioned in the same horizontal plane, and a third post is offset from (above or below) the other two posts to provide stability to the training aid when positioned on the dog's neck.

### BRIEF DESCRIPTION OF THE DRAWINGS

FIG. 1 is a rear perspective view of a new and improved trailer incorporating the unique aspects of the present invention and shown as used with a collar.

FIG. 2 is an enlarged rear perspective view of the training aid of FIG. 1.

FIG. 3 is a side view of the training aid.

FIG. 4 is a front vie of the training aid.

FIG. 5 is a rear perspective view of the training aid.

FIGS. 6 and 7 are back and front perspective views of an alternate embodiment training aid.

While the invention is susceptible of various modifications and alternative constructions, certain illustrated embodiments have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

Reference numerals shown in the drawings correspond to the following:

10—training aid

12—body

14—end openings in body

16a—horizontally aligned posts

16b—offset center post

18—top and bottom of center portion 22 of body

20—collar

22—center portion of body

24—end portions of body

24a—upper surface of end portions 24

24b—lower surface of end portions 24

26a—front side of body

26b—back side of body

28—leash connection ring

110—training aid (alternate embodiment)

112—body of training aid 100

114—end openings in body 102

116—horizontally aligned posts of aid 100

120—upper and lower surfaces at center portion of body 102

122—center portion of body 112

124—end portions of body 112

124a—upper surface of end portions 124

124b—lower surface of end portions 124

126a—front side of body 112

126b—back side of body 112

A-A—upper horizontal plane

B-B—lower horizontal plane

C—longitudinal center axis

D—lateral center axis

E—transverse center axis

### DETAILED DESCRIPTION OF THE INVENTION

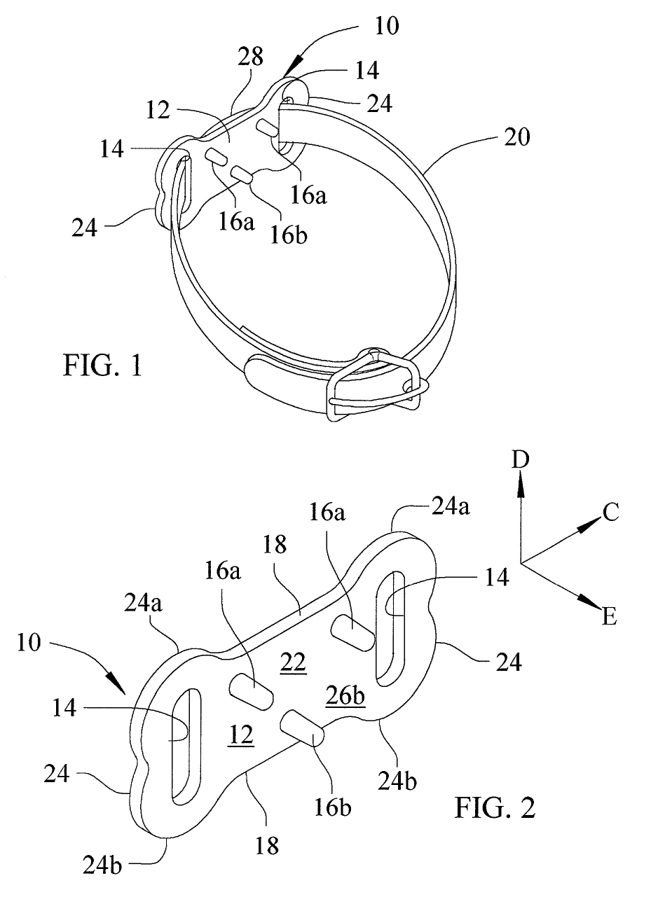

For purposes of illustration, a preferred embodiment of the present invention is shown in the drawings in the form of a dog training aid 10 (FIGS. 1-5) adapted for use with a conventional dog collar 20.

Briefly, the training aid 10 consists of a generally bone-shaped body 12 provided with elongated openings 14 at each end for receiving the collar therethrough, and three short pegs or posts 16a, 16b projecting rearwardly from the body.

More particularly, the body 12 is defined by a longitudinally extending center portion 22 having generally parallel top and bottom surfaces 18, and opposing free ends 24 that extend longitudinally from the center portion. In the embodiment shown, the body is generally planar, with flat front and back sides 26a and 26b extending parallel at a substantially constant thickness. Alternately, for example, the body or the back side may be formed with a curvature, with the free ends curved rearwardly for a shape that generally conforms to a dog's neck.

To establish the general bone-shape, the center portion 22 of the body 12 is narrowed at its top and bottom 18 as compared with the upper and lower surfaces 24a and 24b of the free ends 24, to approximately the width of the elongated openings 14, and thus to approximately the width of the collar 20 with which the training aid is to be used. In this instance, the corners of the free ends shown are also rounded when viewed in a line along the transverse axis for both aesthetic value, and to assist in avoiding inadvertent discomfort to the dog.

The body 12 is preferably made of a rigid material, to keep its shape on the collar 20, and is preferably formed from integrally molded plastic for relatively low manufacturing costs and a relatively light-weight device. To this end, the body is also preferably generally symmetric with respect to orthogonal axes C-E through the center of the body. Alternately, the body may be formed from a semi-compliant material for curving around the dog's neck when in use. However, in this instance, the posts preferably project from a center portion that is at least somewhat rigid to prevent the posts from substantially giving-way during behavior correction.

The elongated openings 14 extend transversely lengthwise, i.e., generally vertically as shown in the drawings, through the width of the body 12, and are sized to slidably but snugly receive the collar 20 therethrough. In the embodiment shown, the openings are formed with generally parallel elongated opposing sides for ease of manufacture. Alternately, for example, the sides may be otherwise configured, such as provided with a curvature to provide a snug fit with the collar while reducing the side length along which potential friction is present during insertion and removal of the collar.

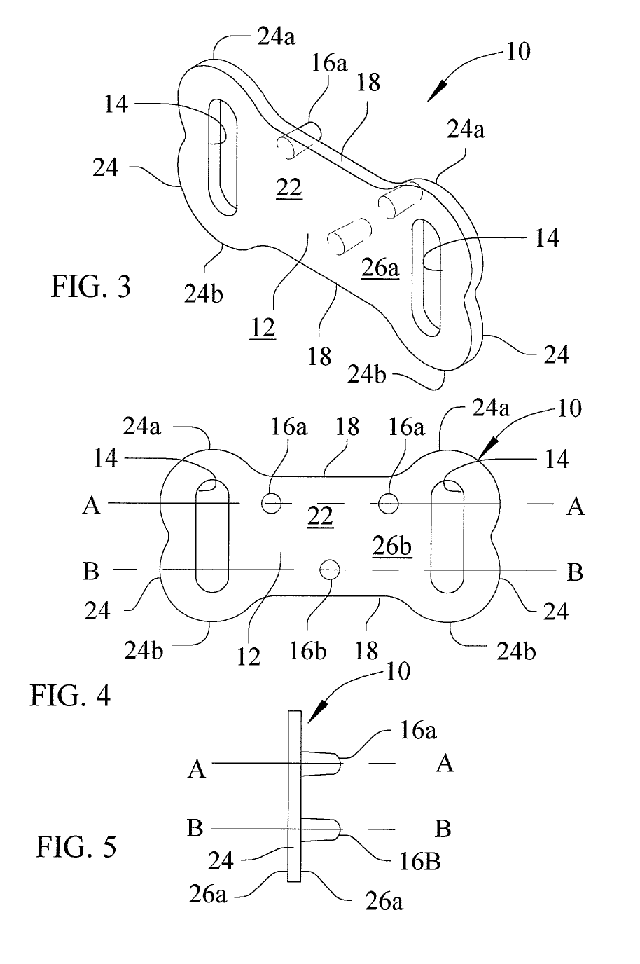

The posts 16a, 16b shown are generally cylindrical, are preferably integrally molded with the body 12 and of approximately equal length, and are provided with rounded ends. Two posts 16a are positioned in the same longitudinal plane, as indicated by upper horizontal dashed lines A-A in FIGS. 3 and 4; and the third post 16b is offset in a second longitudinal plane spaced from the first longitudinal plane, as indicated by lower horizontal dashed lines B-B. The offset arrangement of the pegs provides position stability by preventing the training aid from tipping (i.e., twisting downwardly on the collar) when placed on a dog's neck. The upper posts are preferably approximately equally spaced from the lateral and transverse center axes of the body, and the lower post is preferably located projecting parallel with the transverse axis centrally between the upper posts. In keeping with the non-electrical nature of the training aid 10, the posts 16a, 16b are electrically isolated and/or molded from an electrically non-conductive material.

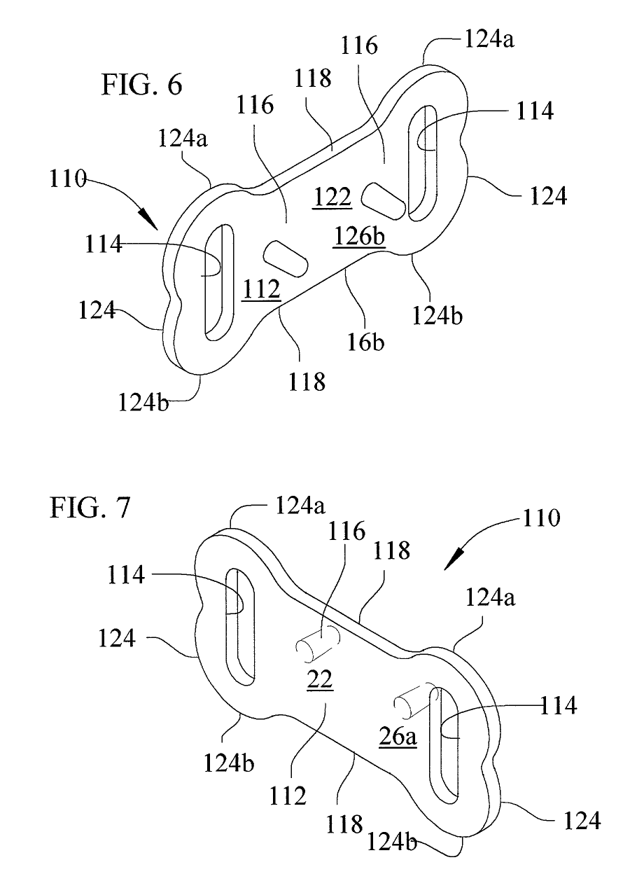

To use the training aid 10, the collar 20 is threaded through one end opening 14 of the training aid, snugly around the front 26a of the body, and through the other end opening 14 as shown in FIG. 1, with the training aid being positioned on the collar oppositely of the leash connection ring 28. The collar is then placed around the dog's neck so that the rounded ends of the posts 16a, 16b fit as a normal collar; i.e., such that the ends of the posts are proximate to but spaced from the dog's neck by approximately the thickness of two fingers. In the event behavior correction is desired, pulling on a leash attached to the back of the collar will draw the ends of the posts into contact the dog's neck. The posts press to a dog's neck with force in proportion to the amount of tension applied with the leash, and the rounded ends of the posts provide notification of behavior correction, without causing undue discomfort to the dog. Thus, increasing tension applied by the leash will result in increasing pressure of the posts on the dog's neck, and progressively severe notification of correction. This leash tension may be supplied directly by the trainer, or by a training leash such as is used with a second collar without a training aid and a second leash. An alternate embodiment training aid 110 of substantially the same construction as training aid 10 is illustrated in FIGS. 6 and 7, with similar parts and features being indicated with the same reference numbers incremented by 100. In this instance, the training aid 110 is provided with only two, horizontally aligned posts 116a, and would be most useful for smaller sized training aids (such as for smaller dogs) where the weight of the aid is very small and tipping is not generally a problem. Alternate numbers of posts may also be provided within the scope of the present invention.

Those skilled in the art will recognize that additional alternate embodiments fall within the scope of the invention, including, but not limited to, the alternate arrangements mentioned above, and a training aid with an alternately shaped body or alternately shaped posts.

From the foregoing, it will be apparent that the present invention brings to the art a new and improved, non-electrical dog training aid provided with unique construction and correction post arrangement and adapted for use with a conventional dog collar.

1. A non-electrical dog training aid adapted for use with a dog collar, the training aid comprising:
a) a body including
(1) a longitudinally extending center portion having a front side and a back side, and
(2) first and second opposing free ends extending longitudinally from said center portion, said first and second free ends being provided with first and second elongated, transversely lengthwise extending openings, respectively, for threading the collar therethrough and along the front side of the center portion; and
b) first and second posts projecting rearwardly from the back side of said center portion.

2. The dog training aid as defined in claim 1 in which said body is rigid, and said body and posts are formed from integrally molded plastic.

3. The dog training aid as defined in claim 1 in which said posts are of equal length.

4. The dog training aid as defined in claim 1 in which said posts are provided with rounded free ends.

5. The dog training aid as defined in claim 1 in which said body is generally planar, with said front side and said back side parallel to one another.

6. The dog training aid as defined in claim 1 in which said center portion includes a top and a bottom, and said first and second free ends include upper and lower surfaces, said center portion being narrower than said first and second free ends as defined by the spacing between said top and bottom and said upper and lower surfaces.

7. The dog training aid as defined in claim 6 in which said upper and lower surfaces are formed rounded when viewed in a line along a transverse axis through the body.

8. The dog training aid as defined in claim 1 in which said first and second posts are longitudinally aligned with one another.

9. A non-electrical dog training aid adapted for use with a dog collar, the training aid comprising:
a) a body including
(1) a longitudinally extending center portion having a front side and a back side, and
(2) first and second opposing free ends extending longitudinally from said center portion, said first and second free ends being provided with first and second elongated, transversely lengthwise extending openings for threading the collar therethrough and along the front side of the center portion; and
b) first and second posts projecting rearwardly from the back side of said center portion in a first longitudinal plane; and
c) a third post projecting rearwardly from the back side of said center portion in a second longitudinal plane parallel to but spaced from said first plane.

10. The dog training aid as defined in claim 9 in which said first and second posts are located oppositely with respect to said third post.

11. The dog training aid as defined in claim 9 in which said body is rigid, and said body and posts are formed from integrally molded plastic.

12. The dog training aid as defined in claim 9 in which said posts are of equal length.

13. The dog training aid as defined in claim 9 in which said posts are provided with rounded free ends.

14. The dog training aid as defined in claim 9 in which said body is generally planar, with said front side and said back side generally parallel to one another.

15. The dog training aid as defined in claim 9 in which said center portion includes a top and a bottom, and said first and second free ends include upper and lower surfaces, said center portion being narrower than said first and second free ends as defined by the spacing between said top and bottom and said upper and lower surfaces.

16. The dog training aid as defined in claim 15 in which said upper and lower surfaces are formed rounded when viewed in a line along a transverse axis through the body.

17. A non-electrical dog collar training aid comprising:
a) a rigid body including
(1) a longitudinally extending center portion having a front side and a back side, and
(2) first and second opposing free ends extending longitudinally from said center portion;
b) first and second posts projecting rearwardly from the back side of said center portion in a first longitudinal plane; and
c) a third post projecting rearwardly from the back side of said center portion in a second longitudinal plane parallel to but spaced from said first plane.

18. The dog training aid as defined in claim 17 in which said first and second posts are located oppositely with respect to said third post.

19. The dog training aid as defined in claim 17 in which said body and said posts are formed from integrally molded plastic.

20. The dog training aid as defined in claim 17 in which said posts are of equal length.

21. The dog training aid as defined in claim 17 in which said posts are provided with rounded free ends.

22. The dog training aid as defined in claim 17 in which said body is generally planar, with said front side and said back side parallel to one another.

23. The dog training aid as defined in claim 17 in which said center portion includes a top and a bottom, and said first and second free ends include upper and lower surfaces, said center portion being narrower than said first and second free ends as defined by the spacing between said top and bottom and said upper and lower surfaces.

24. The dog training aid as defined in claim 23 in which said upper and lower surfaces are formed rounded when viewed in a line along a transverse axis through the body.

25. A non-electrical dog training aid adapted for use with a dog collar, the training aid comprising:
a) a rigid, planer, generally bone-shaped body having
(1) parallel front and back sides, there being a longitudinal center axis extending parallel between said front and back sides,
(2) a generally rectangular center portion having top and bottom surfaces extending between said front and back sides and generally parallel to said longitudinal center axis, and
(3) first and second free ends extending from said center portion, said first and second free ends being provided with first and second elongated, transversely lengthwise extending openings for threading the collar therethrough and along said front side, said ends having upper and lower edges extending between said front and back surfaces, said upper and lower edges being above and below said top and bottom surfaces of the center section with respect to said longitudinal center axis; and
b) first and second posts of approximately equal length projecting rearwardly from the back side of said center portion, said body and said posts being formed from integrally molded plastic.

26. The dog training aid as defined in claim 25 in which said first and second posts are longitudinally aligned with one another, said training aid further comprising a third post projecting rearwardly from the back side of said body offset longitudinally from said first and second posts.
